(19) United States
(12) Patent Application Publication
(10) Pub. No.: US 2017/0168478 A1
(43) Pub. Date: Jun. 15, 2017

(54) VEHICLE REMOTE CONTROL SYSTEM AND METHOD FOR GENERATING PROMPT FEEDBACK IN REMOTE CONTROL DISABLED STATE

(71) Applicant: Hyundai Motor Company, Seoul (KR)

(72) Inventors: Sang-Gu Kwon, Hwaseong (KR); Sang-Min Lee, Pocheon (KR); Su-Hyeon Chae, Hwaseong (KR)

(21) Appl. No.: 15/147,452

(22) Filed: May 5, 2016

(30) Foreign Application Priority Data
Dec. 9, 2015 (KR) 10-2015-0174760

(51) Int. Cl. G05D 1/00; G07C 5/00

(52) U.S. Cl. CPC G05D 1/0011; G07C 5/008

(57) ABSTRACT

A vehicle remote control system includes a telematics center receiving a remote control command from a mobile terminal, delivering the remote control command to a tele-terminal, receiving a remote control result from the tele-terminal, and delivering the remote control result to the mobile terminal. The telematics center receives accessory (ACC) mode information of a vehicle from the tele-terminal, stores the received ACC mode information, and provides the ACC mode information to the mobile terminal upon receiving the remote control command from the mobile terminal.

### CROSS-REFERENCE TO RELATED APPLICATION

This application claims the benefit of and priority to Korean Patent Application No. 10-2015-0174760, filed on Dec. 9, 2015 in the Korean Intellectual Property Office, the disclosure of which is incorporated herein in its entirety by reference.

### BACKGROUND

1. Technical Field

The present disclosure relates generally to vehicle remote control, and more particularly, to a system and method for minimizing a feedback time in a remote control disabled state.

2. Description of the Related Art

A telematics system is a wireless data service system that can be applied in a vehicle capable of accessing a wireless communication network using a wireless modem mounted therein and providing a wireless data service via cooperation between a vehicle manufacturer and a mobile communication provider. Recent vehicles having a telematics function provide various remote control services such as vehicle door open, door close, startup on/off, etc. For such remote control, the vehicle requires a complicated connection structure involving a telematics unit, a body control module (BCM), and a smart key electronic control unit (SMK).

In this regard, the telematics unit receives a remote control command from an external terminal, and the body control module receives the remote control command from the telematics unit via an interface such as a multimedia controller area network (M-CAN) or a BCM transmitter/receiver (BCM_TX/BCM_RX). Meanwhile, the body control module delivers the remote control command received via the telematics unit to the smart key module, and the smart key module processes the received remote control command.

Notably, the remote control service using telematics is not problematic during a remote control-enabled state. However, during a remote control-disabled state, it takes considerable time for a user to receive feedback. In other words, when the modem mounted in the vehicle is turned off or when a vehicle is located in a communication shadow area, remote control is disabled. When a user who does not know that remote control is disabled attempts remote control via an external terminal, it takes considerable time to recognize that remote control is disabled.

Although a feedback reception time may be variously changed according to a processing time of a telematics center, the processing time is generally at least 120 seconds in the current remote control system. Accordingly, there is a need for a remote control method or system for providing prompt feedback indicating a remote control disabled state, while preventing a user from wasting excessive amounts of time in the remote control disabled state.

### SUMMARY

Therefore, the present disclosure has been made in view of the above problems, and it is an object of the present disclosure to provide a vehicle remote control system or method capable of enabling a user to receive feedback indicating a remote control disabled state, without waiting for long periods of time in the vehicle remote control-disabled state.

In accordance with embodiments of the present disclosure, the above and other objects can be accomplished by the provision of a vehicle remote control system including: a telematics center receiving a remote control command from a mobile terminal, delivering the remote control command to a tele-terminal, receiving a remote control result from the tele-terminal, and delivering the remote control result to the mobile terminal. The telematics center receives accessory (ACC) mode information of a vehicle from the tele-terminal, stores the received ACC mode information, and provides the ACC mode information to the mobile terminal upon receiving the remote control command from the mobile terminal.

The ACC mode information may include at least one of current ACC mode on/off-state information of the vehicle and ACC mode state change time information.

When the ACC mode on/off-state information indicates an off-state, the mobile terminal may perform remote control when a predetermined time has not elapsed after changing the ACC mode to the off-state, announce that a modem is in an off-state, and then finish the remote control when the predetermined time has elapsed after changing the ACC mode to the off-state.

The predetermined time may be from a time from when the ACC mode of the vehicle is changed to the off-state to when the modem is turned off.

When the ACC mode on/off-state information indicates an on-state, the mobile terminal may announce that the current ACC mode of the vehicle is in the on-state or that the vehicle is currently located in a communication-disabled area.

The mobile terminal may determine whether the remote control is attempted again after the announcement that the current ACC mode of the vehicle is in the on-state and perform or finish the remote control.

Furthermore, in accordance with embodiments of the present disclosure, the above and other objects can be accomplished by the provision of a vehicle remote control method including: receiving, by a telematics center, a remote control command from a mobile terminal; delivering, by the telematics center, the remote control command to a tele-terminal; receiving, by the telematics center, a remote control result from the tele-terminal; delivering, by the telematics center, the remote control result to the mobile terminal; receiving, by the telematics center, accessory (ACC) mode information of a vehicle from the tele-terminal; storing, by the telematics center, the received ACC mode information; and providing the ACC mode information to the mobile terminal upon receiving the remote control command from the mobile terminal.

According to the present disclosure, the telematics center stores the ACC mode on/off-state information of the vehicle via the tele-terminal mounted in the vehicle in advance and rapidly provides the information to the mobile terminal, such that the user receives prompt feedback indicating that remote control is currently disabled without an excessive waiting time when the modem mounted in the vehicle is turned off or the vehicle is located in the communication-disabled area (i.e., shadow area) such that remote control is disabled.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a diagram showing the configuration of a vehicle remote control system according to embodiments of the present disclosure;

FIG. 2 is a flowchart illustrating a vehicle remote control method of a telematics center for generating prompt feedback in a remote control disabled state according to embodiments of the present disclosure; and

FIG. 3 is a flow diagram of a vehicle remote control system and method for generating prompt feedback in a remote control disabled state according to embodiments of the present disclosure.

It should be understood that the above-referenced drawings are not necessarily to scale, presenting a somewhat simplified representation of various preferred features illustrative of the basic principles of the disclosure. The specific design features of the present disclosure, including, for example, specific dimensions, orientations, locations, and shapes, will be determined in part by the particular intended application and use environment.

### DETAILED DESCRIPTION OF THE EMBODIMENTS

Hereinafter, embodiments of the present disclosure will be described in detail with reference to the accompanying drawings. It is to be understood that the detailed description, which will be disclosed along with the accompanying drawings, is merely intended to describe embodiments of the present disclosure and is not intended to represent all technical ideas of the present disclosure. Therefore, it should be understood that various equivalents and modifications exist which can replace the embodiments described herein.

Along these lines, terminology used herein is for the purpose of describing particular embodiments only and is not intended to be limitative. As used herein, singular forms are intended to include the plural forms as well, unless context clearly indicates otherwise. Also, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Additionally, it is understood that one or more of the below methods, or aspects thereof, may be executed by at least one telematics control unit. The term “telematics control unit” may refer to a hardware device that includes a memory and a processor. The memory is configured to store program instructions, and the processor is specifically programmed to execute the program instructions to perform one or more processes which are described further below. Moreover, it is understood that the below methods may be executed by an apparatus comprising the telematics control unit in conjunction with one or more other components, as would be appreciated by a person of ordinary skill in the art.

Referring now to the presently disclosed embodiments, a user can receive feedback indicating a remote control disabled state without waiting for long periods of time in a state in which remote control of a vehicle is disabled. To this end, a vehicle remote control system according to embodiments of the present disclosure includes a telematics center 20 configured to receive a remote control command from a mobile terminal 10, to deliver the remote control command to a tele-terminal 30, to receive a remote control result from the tele-terminal, and to deliver the remote control result to the mobile terminal. The telematics center receives and stores accessory (ACC) mode information of a vehicle from the tele-terminal and provides the ACC mode information to the mobile terminal upon receiving the remote control command of the mobile terminal.

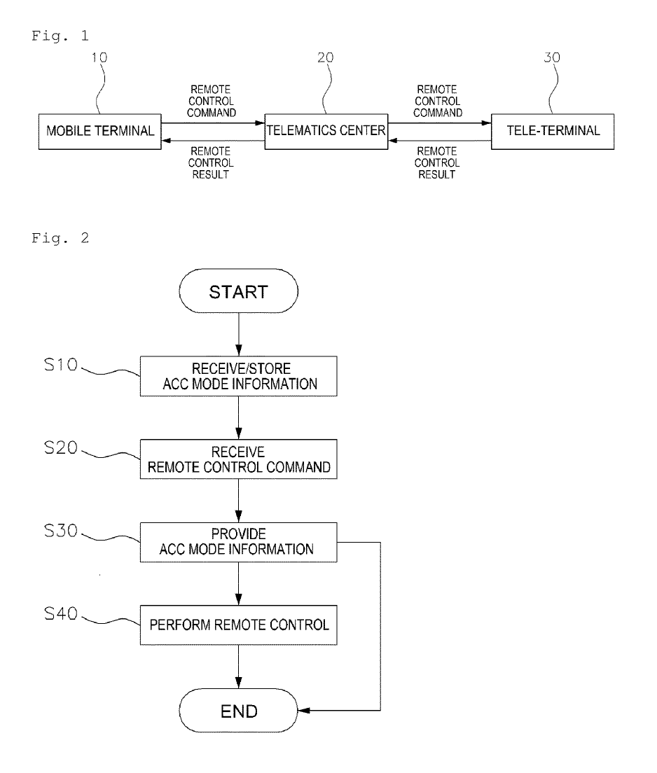

For understanding of description, FIG. 1 shows the configuration of a vehicle remote control system according to embodiments of the present disclosure.

As shown in FIG. 1, a mobile terminal 10 receives a remote control command from a user, transmits the remote control command via the telematics center 20, and receives a remote control result. The telematics center 20 transmits the remote control command received from the mobile terminal to a tele-terminal and receives the remote control result, and a tele-terminal 30 mounted in a vehicle delivers the received remote control command to a vehicle controller via an in-vehicle communication network to perform remote control.

The telematics center 20 receives and stores vehicle accessory (ACC) mode information from the tele-terminal 30 even in a state in which a remote control attempt is not made via the mobile terminal 10 of a user, and provides the ACC mode information to the mobile terminal upon receiving a remote control command of the mobile terminal to feed the information indicating whether vehicle remote control is currently enabled back to the user before the user executes the remote control command.

The ACC mode information includes at least one of ACC mode on/off-state information indicating the current ACC mode state of the vehicle and ACC mode state change time information indicating when the ACC mode is changed from the on-state to the off-state or from the off-state to the on-state, thereby determining whether remote control of the mobile terminal 10 is currently enabled. That is, when the ACC mode on/off-state information indicates the off-state, the mobile terminal 10 performs remote control if a predetermined time has not elapsed after changing the ACC mode to the off-state and announces that the modem is in the off-state and finishes remote control if the predetermined time has elapsed after changing the ACC mode to the off-state.

In contrast, when the ACC mode on/off-state information indicates the on-state, the mobile terminal 10 announces that the current ACC mode is in the on-state or announces that the vehicle is currently in a communication-disabled area (i.e., shadow area) and then determines a remote control attempt and performs remote control if remote control is attempted even in the communication-disabled area.

When remote control is attempted in the remote control disabled state of the vehicle, it is possible to more rapidly provide the user with feedback indicating that remote control is disabled.

FIG. 2 is a flowchart illustrating a vehicle remote control method of a telematics center for generating prompt feedback in a remote control disabled state according to embodiments of the present disclosure.

As shown in FIG. 2, the telematics center 20 receives and stores the ACC mode information of the vehicle from the tele-terminal 30 (S10). This step may be performed at a time interval set by the telematics center or only when the ACC mode of the vehicle is changed from the on-state to the off-state or from the off-state to the on-state. Thereafter, when the remote control command is received from the mobile terminal 10, the telematics center 20 provides the ACC mode information to the mobile terminal (S20). Conventionally, feedback indicating the remote control disabled state is provided to the user after remote control attempts via the tele-terminal 30, the mobile terminal and the telematics center. However, in the present disclosure, via this step, the remote control-disabled state of the vehicle may be more rapidly delivered to the user.

When the telematics center 20 receives an additional remote control command from the mobile terminal 10 (S30), a basic remote control step of delivering the remote control command to the tele-terminal 30 and delivering a remote control result received from the tele-terminal to the mobile terminal is performed (S40).

When an additional remote control attempt is not made in a state of delivering the remote control disabled state to the user in the above-described step, remote control is finished.

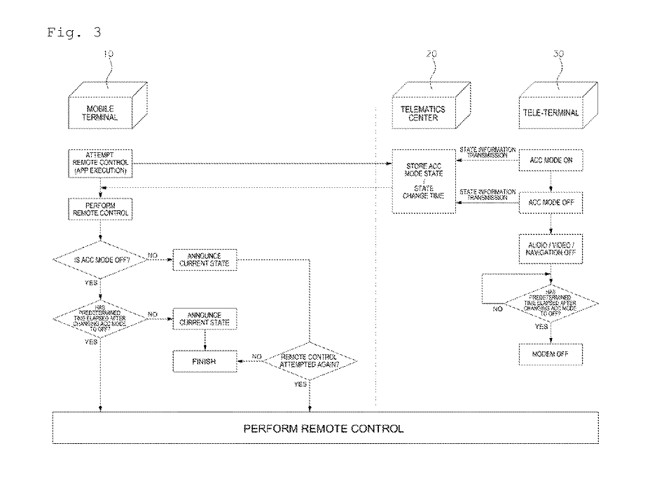

FIG. 3 is a flow diagram of a vehicle remote control system and method for generating prompt feedback in a remote control disabled state according to embodiments of the present disclosure.

As shown in FIG. 3, first, the tele-terminal 30 mounted in the vehicle transmits the ACC mode on/off-state information (including the state change time information) of the vehicle to the telematics center 20.

Unlike conventional techniques in which the above-described information is provided via the telematics center 20 only when a request of an external terminal is received, in the present disclosure, the telematics center stores the ACC mode information of the vehicle in advance and rapidly provides the ACC mode information of the vehicle when remote control is attempted.

More specifically, although the information may be transmitted at a predetermined time interval, the information is preferably transmitted from the tele-terminal 30 to the telematics center 20 when the ACC mode of the vehicle is changed from the off-state to the on-state, and information indicating that the ACC mode of the vehicle is changed from the on-state to the off-state and information on when the ACC mode of the vehicle is changed to the off-state are transmitted to the telematics center.

In some cases, the telematics center 20 may not receive and store the state change time information from the tele-terminal 30 and, instead, the telematics center may autonomously store a time when the ACC mode on/off-state information of the vehicle is received and use the time in subsequent steps.

Thereafter, the telematics center 20 stores the information related to the ACC mode of the vehicle and provides the information to the mobile terminal when remote control is attempted by executing an application of the mobile terminal 10 (or even when no remote control attempt is made).

The mobile terminal 10 acquires the information related to the current ACC mode of the vehicle before the remote control enabled/disabled-state is fed back, thereby more rapidly performing or finishing vehicle remote control via subsequent steps.

When the mobile terminal 10 attempts remote control, the current ACC mode state of the vehicle is checked using the acquired information. At this time, when the current ACC mode state of the vehicle indicates the off-state, whether a predetermined time has elapsed after changing the ACC mode of the vehicle to the off-state is determined. When it is determined that the predetermined time has not elapsed after changing the ACC mode to the off-state, the tele-terminal 30, the telematics center 20 and the mobile terminal perform remote control and, when it is determined that the predetermined time has elapsed after changing the ACC mode to the off-state, the mobile terminal announces that the modem is in the off-state and finishes remote control.

When the ACC mode is in the off-state, generally, audio, video and navigation units of the tele-terminal are simultaneously turned off and the modem is turned off after a predetermined time. The predetermined time may be, as an example, 96 hours or 192 hours; though the predetermined time is not limited as such and may be changed.

In contrast, when the current ACC mode of the vehicle is in the on-state, the mobile terminal 10 announces that the current ACC mode is in the on-state or announces that the vehicle is currently in a communication-disabled area (i.e., shadow area) and then determines a remote control attempt and performs or finishes remote control via the tele-terminal 30, the telematics center 20 and the mobile terminal according to the checked result.

The ACC mode state information transmitted to the mobile terminal 10 via the telematics center 20 may indicate the on-state in the following two states.

First, the ACC mode of the vehicle is normally in the on-state. In this case, the modem is normally turned on and, in this case, the remote control command is not necessary and the user is likely to perform the remote control command.

Second, the ACC mode of the vehicle is abnormally in the on-state. In this case, the vehicle is located in a communication-disabled area (i.e., shadow area). The actual ACC mode of the vehicle is in the off-state but transmission of the ACC mode state information to the telematics center 20 fails due to the communication disabled state. In this case, communication between the telematics center and the tele-terminal 30 is disabled and thus the remote control service is disabled.

Accordingly, when the ACC mode of the vehicle is in the on-state, the current state is indicated, whether remote control is enabled is checked again and remote control is performed or finished according to the checked result.

As a result, embodiments of the present application provide prompt feedback to the user via the above-described steps as compared to the related art. More specifically, the telematics center 20 stores the ACC mode on/off-state information of the vehicle via the tele-terminal 30 mounted in the vehicle in advance and rapidly provides the information to the mobile terminal 10, such that the user receives prompt feedback indicating that remote control is currently disabled without an excessive waiting time when the modem mounted in the vehicle is turned off or the vehicle is located in the communication-disabled area such that remote control is disabled.

Conventionally, a time required to feed back the remote control disabled-state is about 120 seconds or more. However, in the present disclosure, a time required to feed back the remote control-disabled state can be about 1 second. Therefore, it is possible to improve the quality of the remote control service and maximize user satisfaction.

Although the embodiments of the present invention have been disclosed for illustrative purposes, those skilled in the art will appreciate that various modifications, additions and substitutions are possible, without departing from the scope and spirit of the embodiments as recited in the accompanying claims.

What is claimed is:

1. A vehicle remote control system comprising:
a telematics center receiving a remote control command from a mobile terminal, delivering the remote control command to a tele-terminal, receiving a remote control result from the tele-terminal, and delivering the remote control result to the mobile terminal,
wherein the telematics center receives accessory (ACC) mode information of a vehicle from the tele-terminal, stores the received ACC mode information, and provides the ACC mode information to the mobile terminal upon receiving the remote control command from the mobile terminal.

2. The vehicle remote control system according to claim 1, wherein the ACC mode information includes at least one of current ACC mode on/off-state information of the vehicle and ACC mode state change time information.

3. The vehicle remote control system according to claim 2, wherein, when the ACC mode on/off-state information indicates an off-state,
the mobile terminal performs remote control when a predetermined time has not elapsed after changing the ACC mode to the off-state, announces that a modem is in an off-state, and then finishes the remote control when the predetermined time has elapsed after changing the ACC mode to the off-state.

4. The vehicle remote control system according to claim 3, wherein the predetermined time is a time from when the ACC mode of the vehicle is changed to the off-state to when the modem is turned off.

5. The vehicle remote control system according to claim 2, wherein, when the ACC mode on/off-state information indicates an on-state,
the mobile terminal announces that the current ACC mode of the vehicle is in the on-state or that the vehicle is currently located in a communication-disabled area.

6. The vehicle remote control system according to claim 5, wherein the mobile terminal determines whether the remote control is attempted again after the announcement that the current ACC mode of the vehicle is in the on-state and performs or finishes the remote control.

7. A vehicle remote control method comprising:
receiving, by a telematics center, a remote control command from a mobile terminal;
delivering, by the telematics center, the remote control command to a tele-terminal;
receiving, by the telematics center, a remote control result from the tele-terminal;
delivering, by the telematics center, the remote control result to the mobile terminal;
receiving, by the telematics center, accessory (ACC) mode information of a vehicle from the tele-terminal;
storing, by the telematics center, the received ACC mode information; and
providing the ACC mode information to the mobile terminal upon receiving the remote control command from the mobile terminal.

8. The vehicle remote control method according to claim 7, wherein the ACC mode information includes at least one of current ACC mode on/off-state information of the vehicle and ACC mode state change time information.

9. The vehicle remote control method according to claim 8, wherein, when the ACC mode on/off-state information indicates an off-state,
the mobile terminal performs remote control when a predetermined time has not elapsed after changing the ACC mode to the off-state, announces that a modem is in an off-state, and then finishes the remote control when the predetermined time has elapsed after changing the ACC mode to the off-state.

10. The vehicle remote control method according to claim 9, wherein the predetermined time is a time from when the ACC mode of the vehicle is changed to the off-state to when the modem is turned off.

11. The vehicle remote control method according to claim 8, wherein, when the ACC mode on/off-state information indicates an on-state,
the mobile terminal announces that the current ACC mode of the vehicle is in the on-state or that the vehicle is currently located in a communication-disabled area.

12. The vehicle remote control method according to claim 11, wherein the mobile terminal determines whether the remote control is attempted again after the announcement that the current ACC mode of the vehicle is in the on-state and performs or finishes the remote control.
